(19) United States
(12) Patent Application Publication
(10) Pub. No.: US 2013/0321998 A1
(43) Pub. Date: Dec. 5, 2013

(54) PROTECTION COVER FOR CONNECTOR

(71) Applicants: YU HAN, Shenzhen City (CN); LEI LIU, Shenzhen City (CN); SHU-NI YI, Shenzhen City (CN); KUN LI, Shenzhen City (CN); ZHENG-HENG SUN, Tu-Cheng (TW)

(72) Inventors: YU HAN, Shenzhen City (CN); LEI LIU, Shenzhen City (CN); SHU-NI YI, Shenzhen City (CN); KUN LI, Shenzhen City (CN); ZHENG-HENG SUN, Tu-Cheng (TW)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/531,426

(22) Filed: Jun. 22, 2012

(30) Foreign Application Priority Data
May 30, 2012 (CN) 201210172238.3

(51) Int. Cl. H01R 13/44; G06F 1/16

(52) U.S. Cl. 361/679.02; 439/149

(57) ABSTRACT

A protection cover for a connector includes a non-conductive installing block. The installation block defines a number of positioning holes and a receiving slot. Some pins of the connector are inserted into the positioning holes, and other pins of the connector are received in the receiving slot.

### BACKGROUND

1. Technical Field

The present disclosure relates to protection covers, and particularly to a protection cover for a connector.

2. Description of Related Art

In electronic devices, such as computers or servers, a number of connectors are usually mounted on a motherboard of the electronic devices. A plurality of pins of each connector is exposed on the motherboard. The exposed pins may be damaged during assembly or disassembly of the motherboard.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the views.

FIG. 1 is an exploded, isometric view of an exemplary embodiment of a protection cover, together with a connector.

FIG. 2 is an assembled, isometric view of FIG. 1.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references can mean “at least one.”

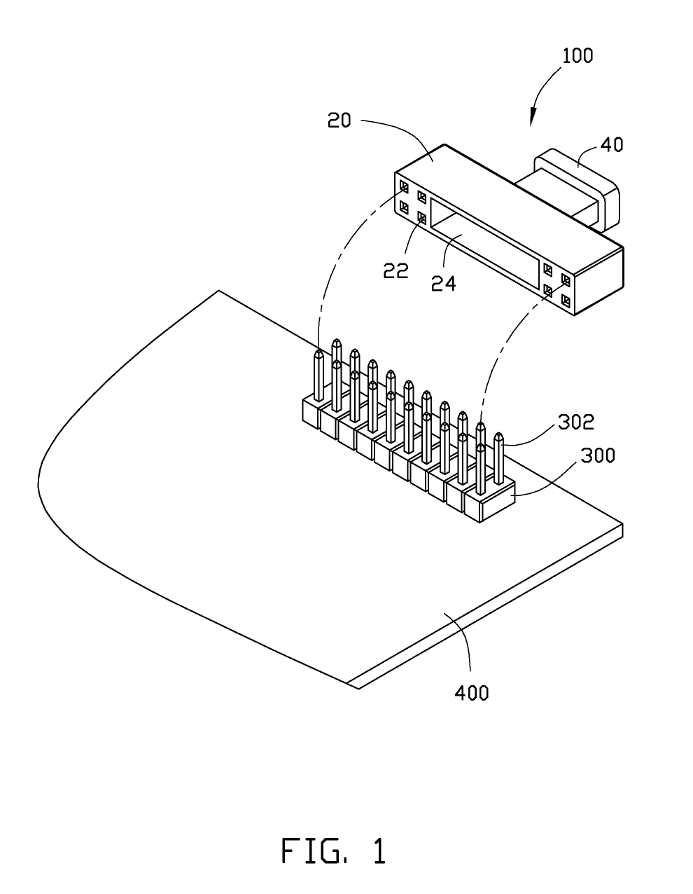

FIG. 1 shows an exemplary embodiment of a protection cover 100 protecting a connector 300. The connector 300 is mounted on a motherboard 400. The connector 300 includes a plurality of pins 302. The protection cover 100 includes a non-conductive installation block 20 and a grip 40.

The installation block 20 is rectangular, and defines a plurality of positioning holes 22 in two opposite ends of a bottom surface of the installation block 20, and a receiving slot 24 in a middle of the bottom surface of the installation block 20, between the positioning holes 22.

The grip 40 is substantially T-shaped, and extending up from a middle of a top surface of the installation block 20.

In the embodiment, the installation block 20 is made of insulated material, such as plastic or rubber.

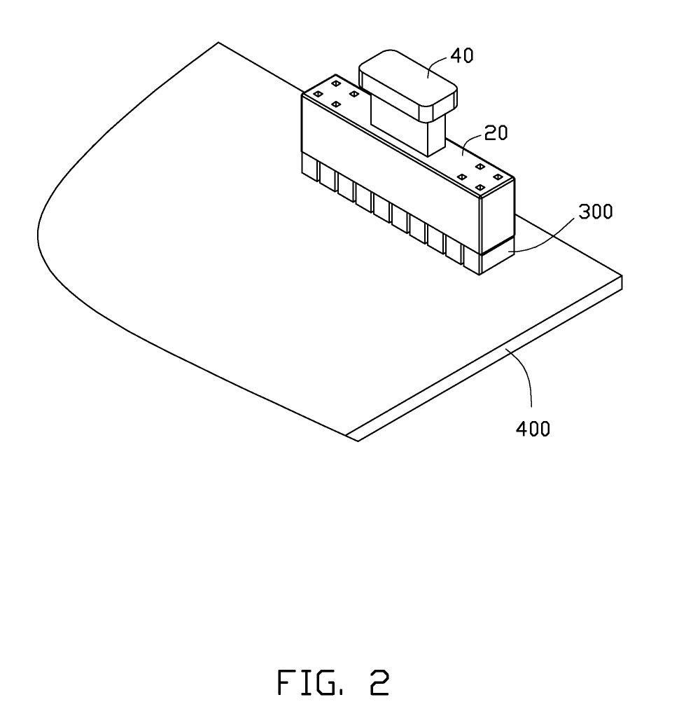

FIG. 2, show that in use, the positioning holes 22 are respectively aligned with some of the pins 302. The grip 40 is pressed toward the motherboard 400, the corresponding pins 302 of the connector 300 are inserted into the positioning holes 22, and other pins 302 of the connector 300 are received in the receiving slot 24 of the installation block 20. Therefore, the pins 302 of the connector 300 are received in the installation block 20, to prevent the pins 302 from being deformed or damaged.

While the disclosure describes examples and embodiments, it is to be understood that the disclosure is not limited thereto. To the contrary, the disclosure is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A protection cover for a connector with a plurality of pins, the protection cover comprising:
a non-conductive installation block defining a plurality of positioning holes in a bottom surface for receiving some of the pins of the connector, and defining a receiving slot in the bottom surface for receiving other pins of the connector.

2. The protection cover of claim 1, wherein the installation block is rectangular, the receiving slot is defined in a middle of the bottom surface of the installation block, and the positioning holes are defined in two opposite ends of the bottom surface of the installing block.

3. The protection cover of claim 2, further comprising a grip extending up from a middle of a top surface of the installing block.

4. The protection cover of claim 1, wherein the installation block is made of plastic.

5. The protection cover of claim 1, wherein the installation block is made of rubber.

6. An electronic device, comprising:
a motherboard;
a connector mounted on the motherboard, and comprising a plurality of pins; and
a protection cover comprising a non-conductive installing block, the installation block defining a plurality of positioning holes and a receiving slot in a bottom surface;
wherein some pins of the connector are inserted into the positioning holes, and other pins of the connector are received in the receiving slot.

7. The electronic device of claim 6, wherein the installation block is rectangular, the receiving slot is defined in a middle of the bottom surface of the installation block, and the positioning holes are defined in two opposite ends of the bottom surface of the installing block.

8. The electronic device of claim 7, wherein the protection cover further comprises a grip extending up from a middle of a top surface of the installing block.

9. The electronic device of claim 6, wherein the protection cover is made of plastic or rubber.
